(19) United States
(12) Patent Application Publication
(10) Pub. No.: US 2024/0123748 A1
(43) Pub. Date: Apr. 18, 2024

(54) METHOD AND DEVICE FOR COATING A SURFACE

(71) Applicant: HOMAG GmbH, Schopfloch (DE)

(72) Inventors: Boris THIESSEN, Rheda-Wiedenbrück (DE); Thomas BETTERMANN, Bielefeld (DE); Ludwig ALBRECHT, Dornstetten-Aach (DE); Peter WULZINGER, Sulz a. N. (DE)

(21) Appl. No.: 18/277,567

(22) PCT Filed: Feb. 11, 2022
(86) PCT No.: PCT/EP2022/053343

§ 371 Date: Aug. 16, 2023

(30) Foreign Application Priority Data
Feb. 16, 2021 (DE) 10 2021 103 564.3

(51) Int. Cl. B41M 5/00; B41M 3/06; B41M 7/00

(52) U.S. Cl. CPC B41M 5/0047; B41M 3/06; B41M 5/0023; B41M 7/0081

(57) ABSTRACT

The invention relates to a method and a device for coating a surface of an object, in particular a narrow side of a plate-shaped workpiece. The device and method can be used, for example, in the field of the furniture and components industry.

### TECHNICAL FIELD

The invention relates to a method and a device for coating a surface of an object, in particular a narrow side of a plate-shaped workpiece. The device and method can be used, for example, in the field of the furniture and components industry.

### PRIOR ART

Various methods for coating an object, such as a plate-shaped workpiece, are known in the field of the furniture and components industry. It is, for example, possible to adjust the gloss value of a surface to give the workpiece a specific external appearance in addition to the pattern or colour of the surface. Such workpieces can appear more glossy or more matt as required.

EP 1 990 204 A1 describes, for example, a method for coating a surface of an object comprising the following steps: Providing an object that is to be coated on one surface, and producing a coating on the surface of the object to be coated by means of a coating head that comprises a plurality of outlets for the coating material. Before producing a coating, a desired gloss value of the coated surface is selected from a gloss scale and the coating material is ejected from the outlets onto the surface to be coated in such a manner that the selected gloss value of the coated surface is obtained.

Even though methods for adjusting a gloss value have already proven to be successful, there is a need to further increase the variability of adjustability.

### DESCRIPTION OF THE INVENTION

The invention is based on the object of providing a method and a device that enable a variable adjustment, in particular a continuous adjustment, of the gloss value.

Such a method is provided according to claim 1. Further preferred embodiments are specified in the dependent claims. The invention furthermore relates to a device. Features of the dependent device claims can each be used independently within the context of the method.

The method for coating a surface of a workpiece, in particular a narrow side of a plate-shaped workpiece, comprises the steps of: Applying a first layer, the first layer having a first pattern, and applying a second layer to the first layer, the second layer having a second pattern.

In order to create the desired gloss value of the surface in a targeted manner, a defined pattern is applied in layers to the surface to be coated. This pattern comprises gaps in the coating that cause undirected light refraction (scattered light).

The multiple layers of coating material, in particular a paint and/or a varnish, are accordingly applied in such a way as to produce a specific gloss value. Grains with different gloss values, where required also with a certain feel, can be produced in this manner. Depth effects or other optical effects can, for example, also be created by means of a coating sequence of different coating materials. The gloss value is determined in particular according to DIN ISO 2813. Tests have shown that repeatability can be achieved when forming the gloss value.

A pattern can be set by way of droplet size, droplet spacing, setting a type/signal shape of a voltage pulse at the print head, printing material, or a combination thereof.

An adjustment of a type or signal shape of a voltage pulse at the print head is also described as piezo excitation, within the context of which a piezo element of the print head is operated. The type or signal shape of a voltage pulse for a piezo element of the print head is also referred to as “waveform”.

The method furthermore makes it possible to provide a continuous adjustment of the gloss value of a surface in that the adjustment of the gloss value is performed by means of a respective pattern of the first and second layer.

Even though a first layer and a second layer are described for the cited method, the number of layers is not limited thereto. For example, three, four or more layers may be applied.

According to one embodiment, it is provided that the first pattern and the second pattern differ. This is achieved, for example, by adjusting the droplet size, the droplet spacing, the type of voltage pulse at the print head and/or the printing material.

If a plurality of layers are applied, the generation of depth effects or other optical effects can be achieved by a specific sequence of different printing materials, for example paint, varnish, paint, varnish.

It may furthermore be provided that the first pattern and/or the second pattern is/are formed by gaps in the layer. The first pattern and/or the second pattern may comprise such gaps, as a result of which undirected light refraction (scattered light) is generated.

According to a further embodiment, it is provided that the surface of the workpiece is a surface of a coating material, in particular a strip-shaped coating material. Such a coating material may be made from a plastic material, a veneer or aluminium. The coating material can thus be further refined and the optical appearance can be flexibly adapted to specific requirements.

According to one embodiment of the method, it is provided that application of the first layer and/or the second layer is carried out with an ink or a varnish, in particular a UV ink or a UV varnish, or a solvent-based or water-based ink or varnish.

In order to increase productivity, application of the first layer and the second layer can be carried out in one pass. It is therefore possible to apply at least two layers in one pass to achieve a specific gloss value.

It is preferred that after application of the first layer, an action is performed on the first layer to at least partially cure and/or dry the first layer. The structure/shape of the first layer is thus fixed before the second layer is applied.

In particular an air dryer (in particular a hot air dryer), an IR lamp and/or a UV lamp can be used for this purpose. By means of an air dryer or an IR lamp, solvent-based or water-based inks and varnishes can be acted upon in order to fix the first layer formed by such an ink or varnish, and thus the corresponding pattern. A UV lamp enables rapid fixing of a layer formed by means of a UV ink or UV varnish.

According to a further embodiment, it is provided that application of the first layer and/or the second layer is carried out by means of a digital print head, in particular an inkjet print head. The amount of liquid ejected can thus be set precisely and the respective pattern to be formed can be reproduced with accordingly sharp contours.

According to a further embodiment, it is provided that the layer material of the first layer and the layer material of the second layer differ from one another. For example, the layer material for forming the first layer may be a UV varnish or UV ink, which may be cured, for example, by means of a UV lamp, and thus the curing time can be influenced in a targeted manner. The second layer to be applied to the first layer may be a solvent-based or water-based ink or varnish, with this ink or varnish drying or at least partially curing under ambient conditions.

The invention furthermore relates to a device for coating a surface of a workpiece. The device can be configured in such a manner that the device is configured for coating a narrow side of a plate-shaped workpiece.

The device comprises: a first application device for applying a first layer and a second application device for applying a second layer to the first layer. A control device is furthermore provided, which is configured to control the first application device to form the first layer with a first pattern and to control the second application device to form the second layer with a second pattern.

It is preferred that a setting of the parameters is carried out for application of the first and second layers. In order to carry out setting of the parameters, at least one parameter, preferably a plurality of parameters, can be set, the parameter being selected from: droplet spacing, droplet size, opening time of a nozzle, opening cross section of a nozzle, pressure for ejecting a material for forming the first and/or second layer, and/or selection of a material for forming the first and/or second layer. Adjustment of the gloss value, if required a continuous adjustment, can thus be carried out.

According to one embodiment, the control device is configured to control the first application device and the second application device such that the first pattern and the second pattern differ from one another.

The device is preferably configured to carry out a method according to one of the preceding aspects. A plurality of layers of coating material, in particular a paint and/or a varnish, can thus be applied in such a manner that a certain gloss value is achieved. In particular, grains with different gloss values, where required also with a certain feel, can be produced. Depth effects or other optical effects can, for example, also be created by means of a coating sequence of different coating materials. The gloss value is determined in particular according to DIN ISO 2813.

In order to increase productivity, the device may be configured as a throughfeed device according to one embodiment. It is therefore possible to apply at least two layers in one pass to achieve a specific gloss value.

The device for applying the first and second layers is preferably configured such that the respective layer is provided on a narrow side of a plate-shaped workpiece, such as a wooden board, a chipboard, an MDF board or the like. For this purpose, the first application device and the second application device are configured as narrow-side printing devices.

### BRIEF DESCRIPTION OF THE DRAWINGS

Further features and advantages of a device, a use and/or a method are apparent from the following description of embodiments with reference to the accompanying figures.

FIG. 1 is a perspective view of an embodiment of device for coating a surface.

FIG. 2a schematically shows a first example of a coating of a surface.

FIG. 2b schematically shows a second example of a coating of a surface.

### DESCRIPTION OF EMBODIMENTS

Identical reference numbers that are used in different figures designate identical, corresponding or functionally similar elements.

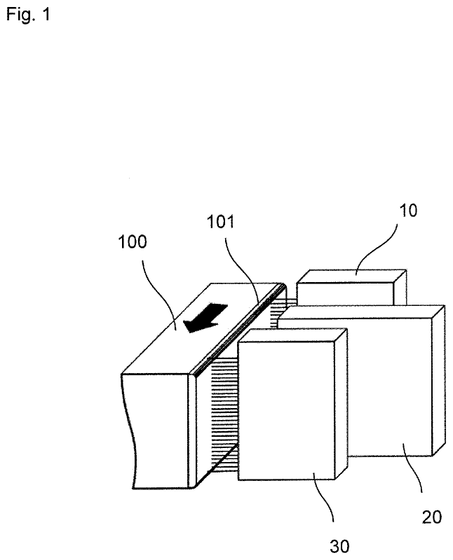

FIG. 1 shows a perspective view of an embodiment of a device for coating a surface of a plate-shaped workpiece 100. The plate-shaped workpiece 100 is provided with a strip-shaped coating material 101 and is moved in a throughput direction by means of a conveying device (not shown).

As the workpiece 100 moves, it enters the region of a first application device 10, which is configured as an inkjet print head. A first layer is applied to the surface of the strip-shaped coating material 101 by the first application device 10.

After application of the first layer by means of the first application device 10, this area of the workpiece 100 enters the region of a UV lamp 20, which is configured to at least partially cure the first layer that is formed by a UV ink or a UV varnish. The structure/shape of the first layer is thus fixed in a defined manner before the second layer is applied. The UV lamp 20 in particular shortens the curing time.

The area provided with the first layer is then guided into the region of a second application device 30, which is also designed as an inkjet print head and is configured to apply a second layer.

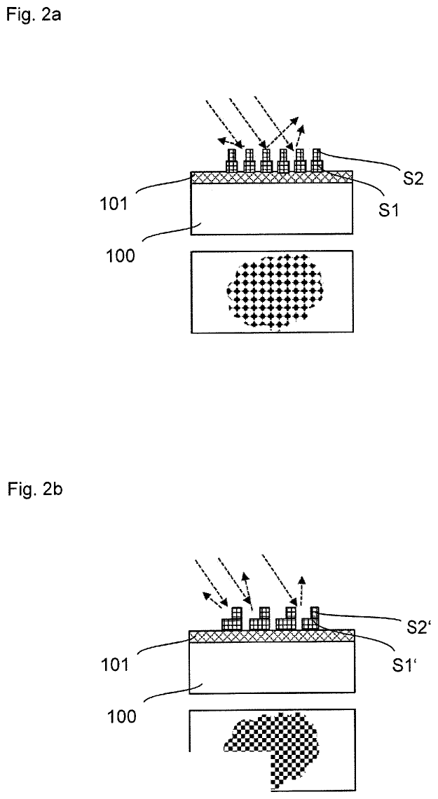

A processing result that can be achieved with the device shown in FIG. 1 can lead to different designs of the applied layer, as is shown in FIGS. 2a and 2b.

In the embodiment example shown in FIG. 2a, the first layer S1 comprises various gaps. The second layer S2 is applied to the first layer S1 in such a manner that gaps are also formed by the second layer S2, but these gaps are larger than the gaps of the first layer S1. A specific reflection behaviour of the light radiation impinging on the coated surface can be achieved in this manner, which makes a surface appear relatively matte.

FIG. 2b shows a further embodiment, in which a first layer S1′ and a second layer S2′ are applied to the coating material 101 provided on the workpiece 100. As compared to the first embodiment example in FIG. 2a, the second layer S2′ also comprises gaps, but the layer portions of the second layer S2′ are arranged such that an edge region of the layer portions of the second layer S2′, as viewed in cross section, is aligned with an edge region of the gaps of the first layer S1′. This leads to the formation of comparatively deep structures, which results in the surface appearing comparatively glossy.

Even though it is described in the context of the present embodiment that the workpiece is supposed to be moved in a throughput direction by means of a conveying device, the workpiece can, according to a further embodiment, also be fixed at least temporarily while a first and second application device as well as a UV lamp, which are combined, for example, in a movable unit, are moved.

Even though a UV lamp is described in the context of the embodiment, with which the first layer can be at least partially cured, it is provided according to a further modification that a hot air dryer and/or an IR lamp is used instead of the UV lamp or in addition thereto. By means of an air dryer or an IR lamp, solvent-based or water-based inks and varnishes can be acted upon in order to fix the first layer formed by such an ink or varnish, and thus the corresponding pattern.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A method for coating a surface of a workpiece, the method comprising the steps of:
applying a first layer, the first layer having a first pattern, and
applying a second layer to the first layer, the second layer having a second pattern.

2. The method according to claim 1, wherein the first pattern or the second pattern is formed by gaps in the layer.

3. The method according to claim 1, wherein the surface of the workpiece is a surface of a coating material.

4. The method according to claim 1, wherein at least one of the applying the first layer or the applying the second layer is carried out with a UV ink or a UV varnish, or a solvent-based or water-based ink or varnish.

5. The method according to claim 1, wherein at least one of the applying the first layer or the second layer is carried out in one pass.

6. The method according to claim 1, wherein after application of the first layer, an action is performed on the first layer to at least partially cure or dry the first layer.

7. The method according to claim 1, wherein at least one of the applying the first layer or the applying the second layer is carried out with inkjet print head.

8. The method according to claim 1, further comprising setting parameters for application of the first and second layers, wherein the parameters comprise at least one of: droplet spacing, droplet size, type of voltage pulse at the print head, opening time of a nozzle, opening cross section of a nozzle, pressure for ejecting a material for forming the first and/or second layer, or selection of a material for forming the first or second layer.

9. The method according to claim 1, wherein a layer material of the first layer and a layer material of the second layer differ from each other.

10. A device for coating a surface of a workpiece, the device comprising:
a first application device for applying a first layer,
a second application device for applying a second layer to the first layer; and
a control device configured to control the first application device to form the first layer with a first pattern and to control the second application device to form the second layer with a second pattern.

11. The method according to claim 1, wherein the surface comprises a narrow side of a plate-shaped workpiece, and the coating material comprises a strip-shaped coating material.

12. The method according to claim 6, wherein the action comprises at least partially curing or drying the first layer an air dryer, an IR lamp, or a UV lamp.
